(19) United States
(12) Patent Application Publication
(10) Pub. No.: US 2016/0360383 A1
(43) Pub. Date: Dec. 8, 2016

(54) MBMS CONTROL METHOD, USER TERMINAL, AND BASE STATION

(71) Applicant: KYOCERA CORPORATION, Kyoto (JP)

(72) Inventor: Kugo MORITA, Yokohama-shi (JP)

(73) Assignee: KYOCERA CORPORATION, Kyoto (JP)

(21) Appl. No.: 15/241,478

(22) Filed: Aug. 19, 2016

Related U.S. Application Data
(63) Continuation of application No. PCT/JP2015/054701, filed on Feb. 20, 2015.

(30) Foreign Application Priority Data
Feb. 21, 2014 (JP) 2014-032299

(51) Int. Cl. H04W 4/06; H04W 76/06; H04W 76/02

(52) U.S. Cl. CPC H04W 4/06; H04W 76/02; H04W 76/06; H04L 12/189

(57) ABSTRACT

An MBMS control method comprises: a step of starting, by a network, delivery of MBMS data at a first time; a step of starting, by a user terminal, reception of the MBMS data at a second time later than the first time; and a step of requesting, by the user terminal, to the network, unicast delivery of a first MBMS data portion that is the MBMS data delivered between the first time and the second time.

### TECHNICAL FIELD

The present disclosure relates to an MBMS control method, a user terminal, and a base station used in a mobile communication system.

### BACKGROUND ART

In 3GPP (3rd Generation Partnership Project) which is a project aiming to standardize a mobile communication system, a specification for MBMS (Multimedia Broadcast Multicast Service) is designed (for example, see Non Patent Document 1).

In the MBMS, a user terminal receives MBMS data (multimedia contents) that is delivered by multicast/broadcast from a network of the mobile communication system.

### PRIOR ART DOCUMENT

### Non-Patent Document

Non Patent Document 1: 3GPP Technical Specification “TS 36.300 V12.0.0” Jan. 10, 2014

### SUMMARY

After the network starts the broadcast/multicast delivery of the MBMS data, the user terminal may start receiving (that is, intercepting) the MBMS data.

In such a case, there's a problem that the user terminal, which is capable of playing back from a middle of the MBMS data, but is not capable of playing back the MBMS data from a start.

Therefore, an object of the present disclosure is to provide an MBMS control method, a user terminal, and a base station with which it is possible to play back MBMS data from a start even when the MBMS data is intercepted.

An MBMS control method according to a first aspect is a method used in a mobile communication system. The MBMS control method comprises: a step of starting, by a network, delivery of MBMS data at a first time; a step of starting, by a user terminal, reception of the MBMS data at a second time later than the first time; and a step of requesting, by the user terminal, to the network, unicast delivery of a first MBMS data portion that is the MBMS data delivered between the first time and the second time.

A user terminal according to a second aspect starts receiving MBMS data at a second time, after a network starts delivering the MBMS data at a first time, in a mobile communication system. The user terminal comprises: a controller configured to requests, to the network, unicast delivery of a first MBMS data portion that is the MBMS data delivered between the first time and the second time.

A base station according to a third aspect delivers MBMS data in a mobile communication system. The base station comprises: a controller configured to accumulate, after starting delivering the MBMS data, the delivered MBMS data. The controller delivers by unicast the accumulated MBMS data to a user terminal, on a basis of a request for unicast delivery from the user terminal.

### BRIEF DESCRIPTION OF THE DRAWINGS

FIG. 1 is a configuration diagram of an LTE system according to a first embodiment and a second embodiment.

FIG. 2 is a block diagram of a UE according to the first embodiment and the second embodiment.

FIG. 3 is a block diagram of an eNB according to the first embodiment and the second embodiment.

FIG. 4 is a protocol stack diagram of a radio interface according to the first embodiment and the second embodiment.

FIG. 5 is a diagram showing an area where MBMS is provided according to the first embodiment and the second embodiment.

FIG. 6 is a diagram showing a network configuration relating to the MBMS according to the first embodiment and the second embodiment.

FIGS. 7(a) to 7(c) are diagrams showing the entire operation according to the first embodiment.

FIG. 8 is a time chart showing an amount of MBMS data received by the UE according to the first embodiment.

FIGS. 9(a) and 9(b) are time charts showing playback control in the UE according to the first embodiment.

FIG. 10 is a time chart showing a case where the playback of MBMS data is not completed by a delivery end time according to the first embodiment.

FIG. 11 is a diagram showing a display example in a user interface according to the first embodiment.

FIG. 12 is a sequence diagram showing delivery control in the eNB according to the first embodiment.

FIG. 13 is a flowchart showing an operation pattern 1 of unicast delivery control according to the first embodiment.

FIG. 14 is a flowchart showing an operation pattern 2 of the unicast delivery control according to the first embodiment.

FIG. 15 is a flowchart showing an operation pattern 1 according to the second embodiment.

FIG. 16 is a flowchart showing an operation pattern 2 according to the second embodiment.

### DESCRIPTION OF THE EMBODIMENT

### Overview of Embodiment

An MBMS control method according to a first embodiment and a second embodiment is a method used in a mobile communication system. The MBMS control method comprises: a step of starting, by a network, delivery of MBMS data at a first time; a step of starting, by a user terminal, reception of the MBMS data at a second time later than the first time; and a step of requesting, by the user terminal, to the network, unicast delivery of a first MBMS data portion that is the MBMS data delivered between the first time and the second time.

In the first embodiment, the MBMS control method further comprises: a step of accumulating, by the user terminal, a second MBMS data portion that is the MBMS data that is started to be received at the second time in a reception buffer; and a step of playing back, by the user terminal, the MBMS data in the order of the first MBMS data portion to the second MBMS data portion on receiving the first MBMS data portion delivered by unicast from the network.

In the first embodiment, in the step of playing back, the user terminal plays back the MBMS data at a predetermined playback speed faster than a standard playback speed so that the playback of the MBMS data is completed by a third time when the delivery of the MBMS data is ended.

In the first embodiment, the MBMS control method further comprises: a step of displaying, when the playback of the MBMS data is not completed by the third time, even if the MBMS data is played back at the predetermined playback speed, by the user terminal, an indication to that effect on a user interface.

In the first embodiment, the MBMS control method further comprises: a step of accumulating, by a base station comprised to receive the MBMS data from an originating device of the MBMS data in the network, after starting delivering the MBMS data at the first time, the delivered MBMS data; and a step of delivering by unicast, on the basis of the request for the unicast delivery, by the base station, the accumulated MBMS data as the first MBMS data portion, to the user terminal.

In the first embodiment, the MBMS control method further comprises: a step of holding without discarding for a fixed time period, by the base station, the accumulated MBMS data: and a step of acquiring, when at least a part of the first MBMS data portion of which the unicast delivery is requested is not accumulated, by the base station, the part which is not accumulated, from the originating device.

In the first embodiment, the step of requesting includes: a step of requesting, by the user terminal, to the network, to delivery by unicast from a start of the MBMS data; and a step of requesting, by the user terminal, the network to stop the unicast delivery in response to receipt, from the network, of the MBMS data corresponding to the first MBMS data portion.

In the first embodiment, the step of delivering by unicast includes: a step of delivering by unicast, by the base station, from a start of the MBMS data, to the user terminal; and a step of stopping, by the base station, the unicast delivery and notifying the user terminal of the stopping of the unicast delivery, in response to having delivered by unicast the MBMS data corresponding to the first MBMS data portion, to the user terminal.

In the second embodiment, in the step of starting delivery of MBMS data, the network starts to deliver by unicast the MBMS data when the number of delivery request terminals of the MBMS data is singular. The MBMS control method further comprises: a step of switching, by the network, the delivery of the MBMS data from by unicast to by broadcast/multicast, when the number of delivery request terminals increases from singular to plural.

In the second embodiment, the MBMS control method further comprises: a step of switching, by the network, the delivery of the MBMS data from by broadcast/multicast to by unicast, when the number of delivery request terminals decreases from plural to singular.

In the second embodiment, the MBMS control method further comprises: a step of transmitting, by the network, a delivery switch notification to the delivery request terminal, when switching the delivery of the MBMS data from by unicast to by broadcast/multicast or when switching the delivery of the MBMS data from by broadcast/multicast to by unicast.

In the second embodiment, the MBMS control method further comprises: a step of requesting, by a user terminal in an idle state, the network to deliver the MBMS data after establishing a connection with the network, when the MBMS data is not delivered by broadcast/multicast.

A user terminal according to the first embodiment and the second embodiment starts receiving MBMS data at a second time, after a network starts delivering the MBMS data at a first time, in a mobile communication system. The user terminal comprises: a controller configured to requests, to the network, unicast delivery of a first MBMS data portion that is the MBMS data delivered between the first time and the second time.

A base station according to the first embodiment and the second embodiment delivers MBMS data in a mobile communication system. The base station comprises: a controller configured to accumulate, after starting delivering the MBMS data, the delivered MBMS data. The controller delivers by unicast the accumulated MBMS data to a user terminal, on a basis of a request for unicast delivery from the user terminal.

### First Embodiment

Hereinafter, a description will be provided for an embodiment when the present disclosure is applied to an LTE system.

(System Configuration)

Hereinafter, a description will be provided for a system configuration of the LTE system according to the first embodiment.

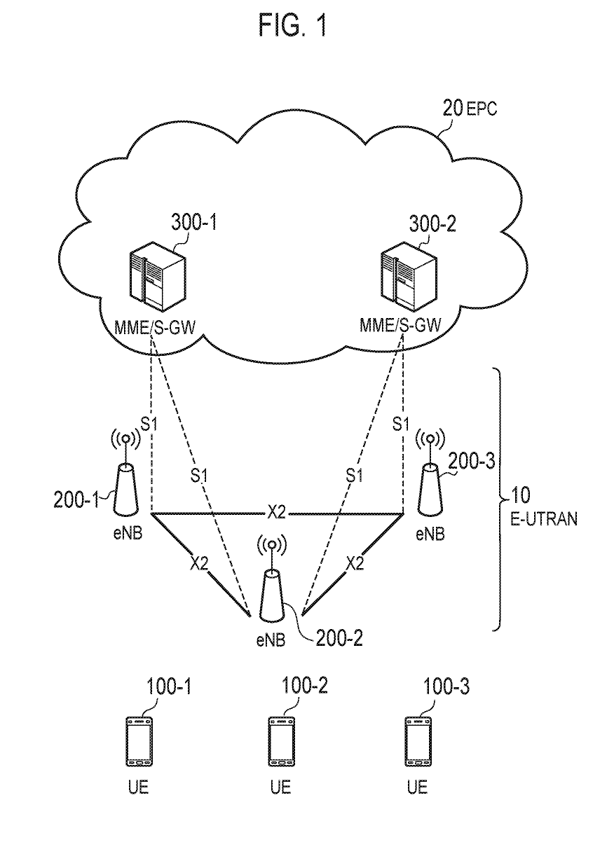

FIG. 1 is a configuration diagram of the LTE system according to the first embodiment. As illustrated in FIG. 1, the LTE system according to the embodiment includes a plurality of UEs (User Equipments) 100, E-UTRAN (Evolved-UMTS Terrestrial Radio Access Network) 10, and EPC (Evolved Packet Core) 20.

The UE 100 corresponds to the user terminal. The UE 100 is a mobile communication device and performs radio communication with a cell (a serving cell). A configuration of the UE 100 will be described later.

The E-UTRAN 10 corresponds to a radio access network. The E-UTRAN 10 includes eNBs 200 (evolved Node-Bs). The eNB 200 corresponds to a base station. The eNB 200 corresponds to the base station. The eNBs 200 are connected mutually via an X2 interface. A configuration of the eNB 200 will be described later.

The eNB 200 manages a cell or a plurality of cells and performs radio communication with UE 100 established a connection with the own cell. The eNB 200, for example, has a radio resource management (RRM) function, a routing function of user data, and a measurement control function for mobility control and scheduling. It is noted that the “cell” is used as a term indicating a minimum unit of a radio communication area, and is also used as a term indicating a function of performing radio communication with the UE 100.

The EPC 20 corresponds to a core network. The EPC 20 includes MMEs (Mobility Management Entities)/S-GWs (Serving-Gateways) 300. The MME is a network node for performing various mobility controls, for example, for the UE 100. The SGW performs transfer control of user data. The MME/S-GW 300 is connected to the eNBs 200 via an S1 interface. It is noted that the E-UTRAN 10 and the EPC 20 constitute a network of the LTE system.

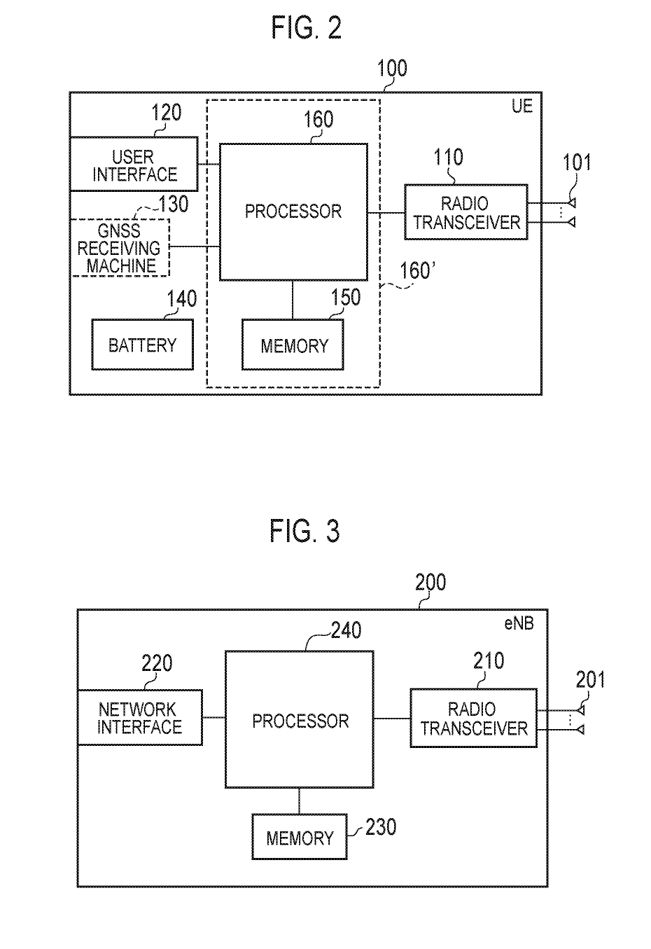

FIG. 2 is a block diagram of the UE 100. As illustrated in FIG. 2, the UE 100 includes a plurality of antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chipset) may be called a processor 160′.

The antennas 101 and the radio transceiver 110 are used to transmit and receive a radio signal. The radio transceiver 110 converts a baseband signal (transmission signal) output from the processor 160 into the radio signal, and transmits the radio signal from the antennas 101. Furthermore, the radio transceiver 110 converts the radio signal received by the antennas 101 into the baseband signal (reception signal), and outputs the baseband signal to the processor 160.

The user interface 120 is an interface with a user carrying the UE 100, and includes, for example, a display, a microphone, a speaker, and various buttons. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The memory 150 has a function of a reception buffer described later. The processor 160 includes a baseband processor that performs modulation and demodulation, encoding and decoding and the like of the baseband signal, and a CPU (Central

Processing Unit) that performs various processes by executing the program stored in the memory 150. The processor 160 may further include a codec that performs encoding and decoding of sound and video signals. The processor 160 implements various processes and various communication protocols described later.

FIG. 3 is a block diagram of the eNB 200. As illustrated in FIG. 3, the eNB 200 includes a plurality of antennas 201, a radio transceiver 210, a network interface 220, a memory 230, and a processor 240. The memory 230 and the processor 240 constitute a controller. Furthermore, the memory 230 may be integrally formed with the processor 240, and this set (that is, a chipset) may be called a processor.

The antennas 201 and the radio transceiver 210 are used to transmit and receive a radio signal. The radio transceiver 210 converts the baseband signal (transmission signal) output from the processor 240 into the radio signal, and transmits the radio signal from the antennas 201. Furthermore, the radio transceiver 210 converts the radio signal received by the antennas 201 into the baseband signal (reception signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes the baseband processor that performs modulation and demodulation, encoding and decoding and the like of the baseband signal and a CPU that performs various processes by executing the program stored in the memory 230. The processor 240 implements various processes and various communication protocols described later.

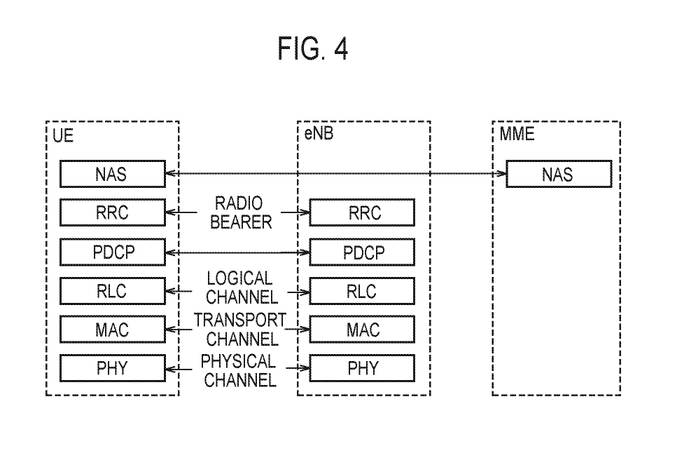

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, user data and control signal are transmitted via the physical channel.

The MAC layer performs preferential control of data, a retransmission process by hybrid ARQ (HARQ), and a random access procedure, and the like. Between the MAC layer of the UE 100 and the MAC layer of the eNB 200, user data and control signal are transmitted via a transport channel. The MAC layer of the eNB 200 includes a scheduler for determining a transport format (a transport block size, a modulation and coding scheme) of an uplink and a downlink, and an assignment resource block to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane handling a control signal. Between the RRC layer of the UE 100 and the RRC layer of the eNB 200, a control signal (an RRC message) for various types of setting is transmitted. The RRC layer controls the logical channel, the transport channel, and the physical channel in response to establishment, re-establishment, and release of a radio bearer. When there is a connection (an RRC connection) between the RRC of the UE 100 and the RRC of the eNB 200, the UE 100 is in a RRC connected state (connected state) and otherwise, the UE 100 is in an RRC idle state (idle state).

A NAS (Non-Access Stratum) layer positioned above the RRC layer performs session management or mobility management, for example.

Further, In the LTE system, OFDMA (Orthogonal Frequency Division Multiple Access) is applied to a downlink, and SC-FDMA (Single Carrier Frequency Division Multiple Access) is applied to an uplink, respectively.

The radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each resource block includes a plurality of subcarriers in the frequency direction. A resource element is configured by one subcarrier and one symbol. Among radio resources (time-frequency resources) allocated to the UE 100, a frequency resource can be specified by a resource block and a time resource can be specified by a subframe (or slot).

(Overview of MBMS)

An overview of MBMS will be described, below. The LTE system according to the first embodiment supports MBMS (Multimedia Broadcast Multicast Service). In the MBMS, the UE 100 receives multimedia contents (MBMS data) that are delivered by multicast/broadcast from a network. It is noted that the UE 100 is capable of receiving MBMS data not only in an RRC connection state but also in an RRC idle state.

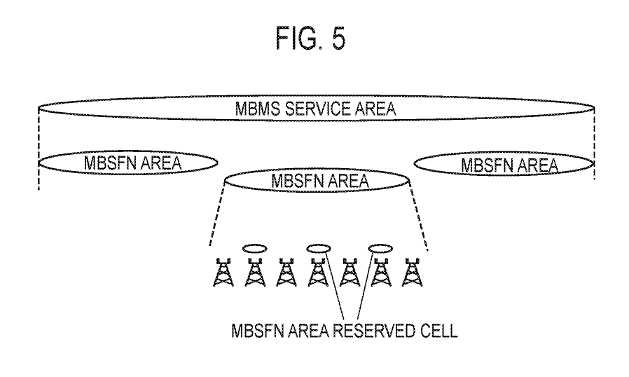

FIG. 5 is a diagram showing an area where the MBMS is provided.

As shown in FIG. 5, one MBSFN (Multicast-Broadcast Single-Frequency Network) area is configured by a plurality of cells, and an MBMS service area is configured by a plurality of MBSFN areas. One cell may belong to a plurality of MBSFN areas.

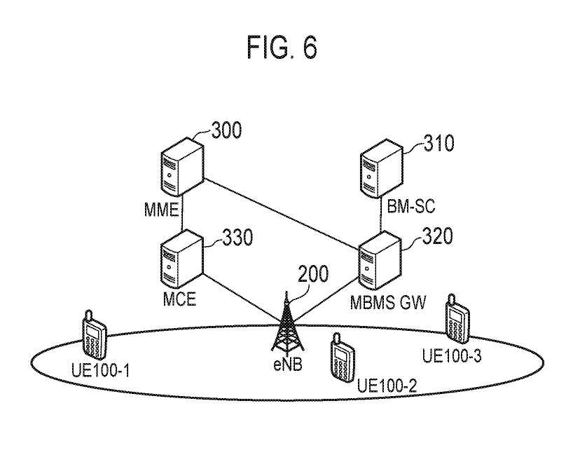

FIG. 6 is a diagram showing a network configuration related to the MBMS.

As shown in FIG. 6, a BM-SC (Broadcast Multicast Service Center) 310 provides a function of delivering the MBMS data. The BM-SC 310 is equivalent to an MBMS-data originating device.

An MBMS GW (MBMS gateway) 320 broadcasts MBMS data to each eNB 200. An MCE (Multi-cell Coordination Entity) 330 controls a radio resource used by each eNB 200 in the same MBSFN area or sets an MBSFN subframe, for example.

The eNB 200 delivers, by broadcast/multicast, MBMS data to a UE 100-1 to a UE 100-3 existing in a cell of the eNB 200. It is noted that the eNB 200 is also capable of delivering, by unicast, the MBMS data to the UE 100 in the RRC connection state.

After the network (eNB 200) starts the broadcast/multicast delivery of the MBMS data, the UE 100 may start receiving (that is, intercepting) the

MBMS data. In such a case, the UE 100, which is capable of playing back from a middle of the MBMS data, is not capable of playing back the MBMS data from a start.

### MBMS Control Method According to First Embodiment

(1) Entire Operation

An MBMS control method with which it is possible to play back MBMS data from a start even when the MBMS data is intercepted will be described, below.

The MBMS control method according to the first embodiment has; a step of starting, by a network, delivery of MBMS data at a first time; a step of starting, by the UE 100, receiving the MBMS data at a second time after the first time; and a step of requesting, by the UE 100, to the network, unicast delivery of a first MBMS data portion that is MBMS data delivered between the first time and the second time.

Further, the first embodiment includes: a step of accumulating, by the eNB 200 that receives the MBMS data from the BM-SC 310, after starting delivery of the MBMS data at the first time, the delivered MBMS data; and a step of delivering, on the basis of the request for the unicast delivery, by the eNB 200, the accumulated MBMS data, as the first MBMS data portion, by unicast, to the UE 100.

Further, the MBMS control method according to the first embodiment has: a step of accumulating, by the UE 100, the second MBMS data portion which is the MBMS data started to be received at the second time into a reception buffer; and a step of receiving, by the UE 100, the first MBMS data portion delivered by unicast from the network and then playing back the MBMS data the first MBMS data portion and the second MBMS data portion in this order.

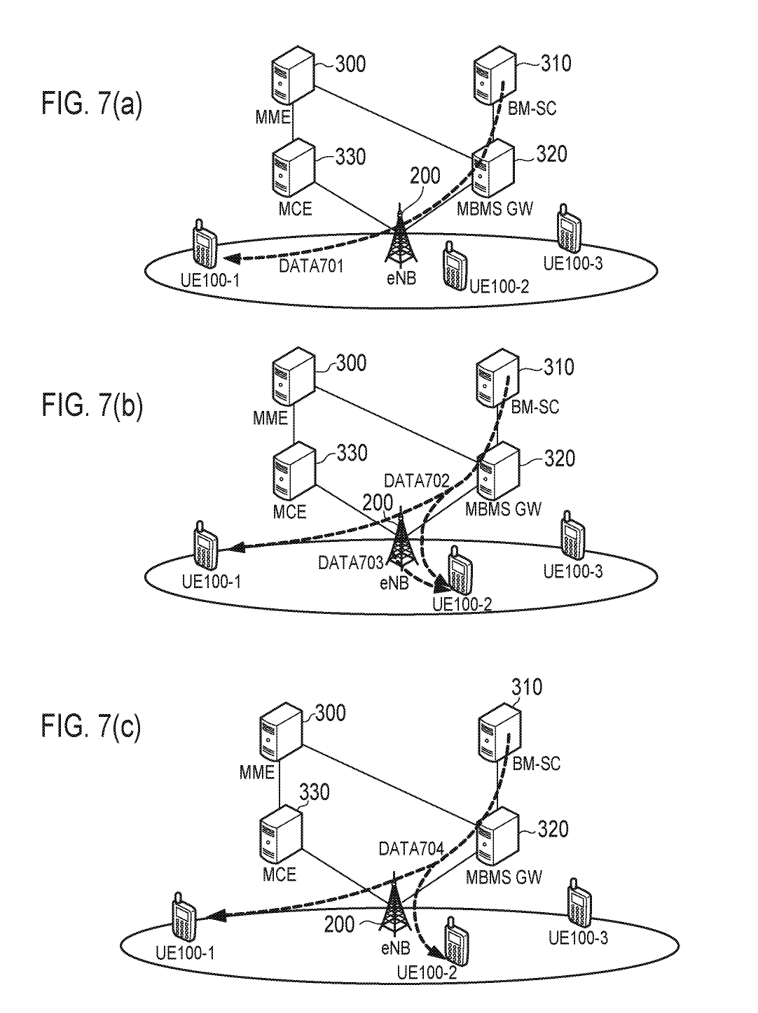

FIGS. 7(a) to 7(c) are diagrams showing the entire operation according to the first embodiment. In FIGS. 7(a) to 7(c), the UE 100-1 is a UE 100 that receives the MBMS data from a start. The UE 100-2 is a UE 100 that intercepts the MBMS data.

As shown in FIG. 7(a), the network starts delivery of the MBMS data at a first time (t01). Here, it is assumed that the network delivers the MBMS data by broadcast/multicast. The MBMS data, for example, is a video and sound content such as a TV program.

The eNB 200 that has received the MBMS data through the MBMS GW 320 from the BM-SC 310 accumulates the delivered MBMS data while starting the delivery of the MBMS data by broadcast/multicast.

It is noted that at this point, the UE 100-1 already starts receiving the MBMS data but the UE 100-2 does not yet start receiving the MBMS data.

As shown in FIG. 7(b), the UE 100-2 starts receiving the MBMS data at a second time (t02). Here, it is assumed that the user of the UE 100-2 wishes to play back the MBMS data from a start and performs an operation with such an indication on the user interface 120. When the UE 100-2 is in the RRC idle state at this point, the UE 100-2 establishes a connection with the eNB 200 and transitions to the RRC connection state.

The UE 100 requests, to the network, unicast delivery of the first MBMS data portion that is the MBMS data delivered between the first time (t01) and the second time (t02). A request may be made to the eNB 200 or to the BM-SC 310. When the request is made to the BM-SC 310, the BM-SC 310 commands, to the eNB 200, the unicast delivery to the UE 100-2.

The eNB 200 delivers by unicast, as the first MBMS data portion, the accumulated MBMS data to UE 100. Although details will be discussed later, when the first MBMS data portion is not completely accumulated, the eNB 200 acquires a shortage from the BM-SC 310.

The UE 100-2 plays back the first MBMS data portion while receiving the first MBMS data portion delivered by unicast. Further, the UE 100-2 accumulates the second MBMS data portion which is the (broadcast/multicast) MBMS data that is started to be received at the second time (t02) in the reception buffer while receiving and playing back the first MBMS data portion.

As shown in FIG. 7(c), after receiving the first MBMS data portion delivered by unicast, the UE 100-2 receives the MBMS data that is broadcast/multicast from the eNB 200 while playing back the first MBMS data portion and the second MBMS data portion in this order.

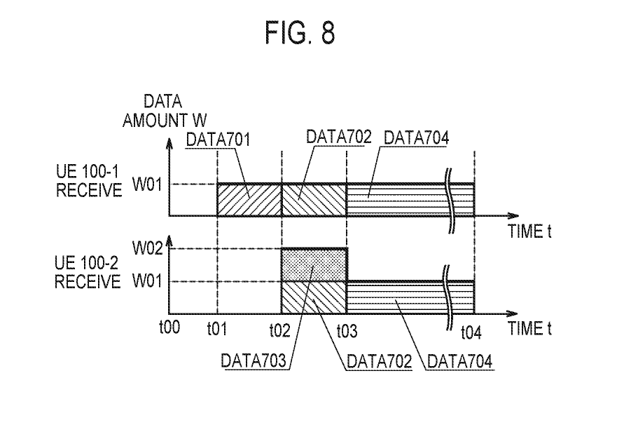

FIG. 8 is a time chart indicating an amount of MBMS data received by each of the UE 100-1 and the UE 100-2.

As shown in FIG. 8, the UE 100-1 starts receiving the MBMS data that is delivered by multicast/broadcast from the eNB 200 at the time t01. The MBMS data received within the period from the time t01 to the time t02 is data 701, the MBMS data received within the period from the time t02 to the time t03 is data 702, and the MBMS data received from the time t03 onwards is data 704.

On the other hand, at the time t02, the UE 100-2 starts receiving the MBMS data that is delivered by multicast/broadcast from the eNB 200 and starts receiving the data delivered by unicast from the eNB 200. The unicast MBMS data received within the period from the time t02 to the time t03 is data 703 and the broadcast/multicast MBMS data received within the period from the time t02 to the time t03 is data 702. Here, the data 703 is data similar to the data 701 received by UE 100-1. Further, the MBMS data received from the time t03 onwards is data 704.

Therefore, even in a case of intercepting the MBMS data, the UE 100-2 is capable of playing back the MBMS data from a start.

(2) Playback Control in UE 100

Playback control in the UE 100-2 will be described, below.

In the first embodiment, the UE 100-2 plays back the MBMS data at a predetermined playback speed that is faster than a standard playback speed so that it is possible to complete the playback of the MBMS data by the time (third time) at which the delivery of MBMS data is completed. As a result, a playback end time (that is, viewing end time) of the MBMS data in the UE 100-2 is made equal to that of the UE 100-1 so as not to affect the subsequent viewing.

It is noted that the predetermined playback speed is about a speed that does not allow the user of the UE 100-2 to recognize that this playback is a fast playback (for example, 1.1 times the usual speed). Until it is estimated that it is possible to make the playback end time of the MBMS data in the UE 100-2 equal to that of the UE 100-1, the fast playback of the MBMS data is performed.

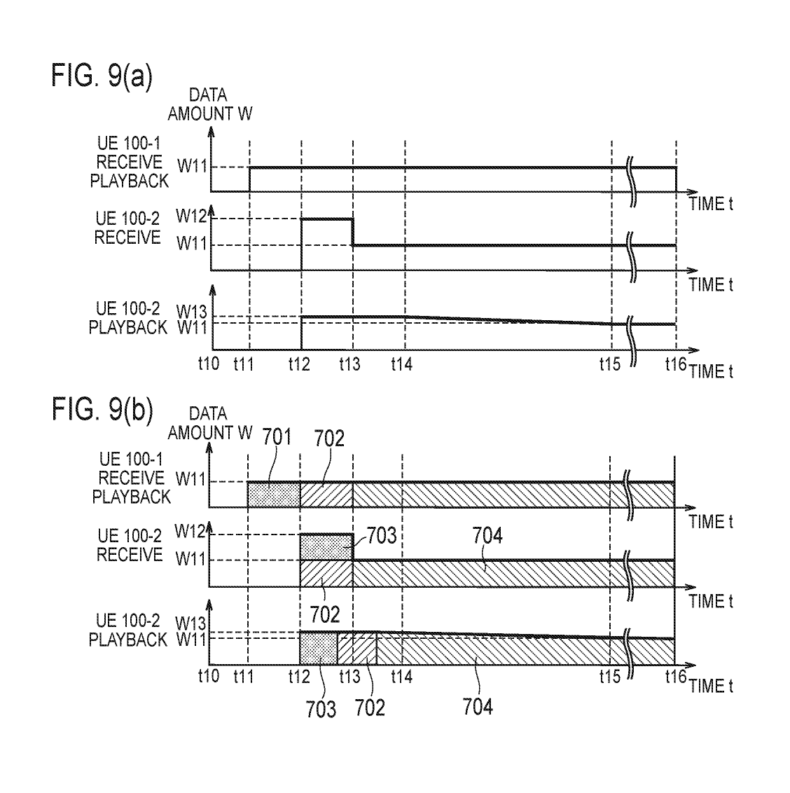

FIGS. 9(a) and 9(b) are time charts indicating the playback control in the UE 100-2. FIG. 9(a) shows an overview of the playback control and FIG. 9(b) shows the details of the playback control. Data 701 to 704 in FIG. 9(b) correspond to the data 701 to 704 in FIG. 8.

As shown in FIGS. 9(a) and 9(b), the UE 100-1 that has started reception at a delivery start time t11 (first time) of the MBMS data, receives the MBMS data at a rate of data amount W11, and plays back the MBMS data at a rate of data amount W11 (standard playback speed).

On the other hand, the UE 100-2 that has started reception at a time t12 (second time) later than the delivery start time t11 of the MBMS data, receives the MBMS data (and accumulates in the reception buffer) at the time t12 to a time t13 at a rate of data amount W12 larger than the data amount W11, and receives the MBMS data at a rate of data amount W11 from the time t13 onwards. Therefore, if the MBMS data in the reception buffer is played back with the standard playback speed, then it is not possible to complete the playback of the MBMS data by a delivery end time t16 (third time) of the MBMS data.

Therefore, at the time 12, the UE 100-2 starts the playback of the MBMS data at a predetermined playback speed (rate of data amount W13) that is faster than the standard playback speed. Further, the UE 100-2 determines at a time t14 that it is possible to complete the playback by the delivery end time of the MBMS data, and gradually decreases the playback speed toward a time t15. Then, at the time t15, the UE 100-2 starts the playback with the standard playback speed.

However, a case is also assumed where even when the MBMS data is played back at a predetermined playback speed, the playback of the MBMS data is not completed by the time at which the delivery of the MBMS data is ended (third time). Examples for this case include a case in which reception start time of the UE 100-2 is close to the delivery end time.

The MBMS control method according to the first embodiment further includes: a step of displaying, by the UE 100-2, even when the MBMS data is played back at a predetermined playback speed rather than a standard playback speed, when the playback of the MBMS data is not completed by the delivery end time of the MBMS data, an indication to that effect on a user interface 120 (specifically, a display). Thus, the user of the UE 100-2 is capable of understanding that the playback of the MBMS data is not completed by the delivery end time.

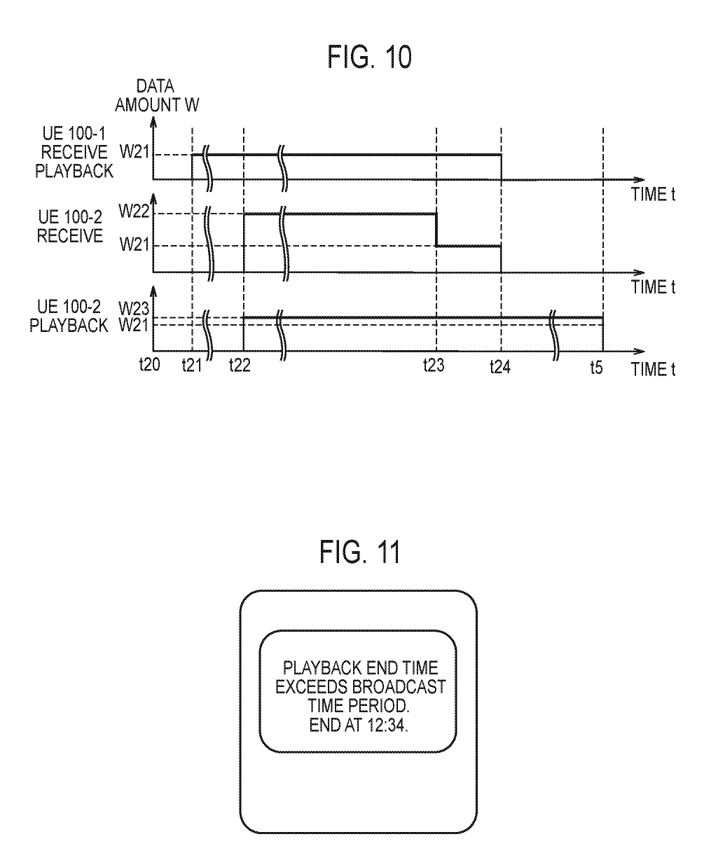

FIG. 10 is a time chart showing a case where the playback of the MBMS data is not completed by the delivery end time.

As shown in FIG. 10, the UE 100-2 that has started the reception at a time t22 (second time) later than a delivery start time t21 of the MBMS data, receives the MBMS data (and accumulates in the reception buffer) from the time 22 to a time 23 at a rate of data amount W22 larger than the standard data amount W21, and receives the MBMS data at a rate of data amount W21 from the time t23 onwards. At a time point of the time t23, a delivery end time t24 of the MBMS data is approaching. In this case, even when the MBMS data is played back at a predetermined playback speed rather than the standard playback speed, the playback of the MBMS data is not completed by a delivery end time t25.

FIG. 11 is a diagram showing a display example in the user interface 120 (display).

As shown in FIG. 11, the UE 100-2 displays with an indication that the playback end time exceeds the delivery end time. Besides, an estimated playback end time may be displayed. It is noted that in addition to the output mode by the display as shown in FIG. 11 or instead of the output mode by the display, a content shown in FIG. 11 may be voice-outputted with a speaker.

(3) Delivery Control in eNB 200

Delivery control in the eNB 200 will be described, below.

The MBMS control method according to the first embodiment has a step of holding without destructing, by the eNB 200, the accumulated MBMS data for a fixed time period. Here, the fixed time period is a delivery time period for delivering the MBMS data (by broadcast/multicast). Alternatively, the fixed time period is a time period until the unicast delivery is completed, when there is a person not completing reception of the unicast delivery after a delivery time period passes by. However, only when there is a holding request from the BM-SC 310 or only when there are at least a predetermined number of delivery request UEs of the MBMS data, the eNB 200 may hold the MBMS data.

In this way, the eNB 200 is capable of appropriately holding the MBMS data while saving the transmission buffer capacity of the eNB 200. It is noted that when there are no delivery request UE of the MBMS data, the eNB 200 (or BM-SC 310) may preferably not deliver the MBMS data. It is possible to understand the number of delivery request UEs by Counting procedure prescribed by the specifications (See 3GPP Technical Specification “TS36.331”), for example.

Further, the MBMS control method according to the first embodiment has: a step of acquiring, by the eNB 200, when at least a part of the first MBMS data portion of which the unicast delivery is requested is not accumulated, the unaccumulated part from the BM-SC 310.

In this way, even when the MBMS data is not held, the eNB 200 is capable of performing the unicast delivery for the UE 100-2.

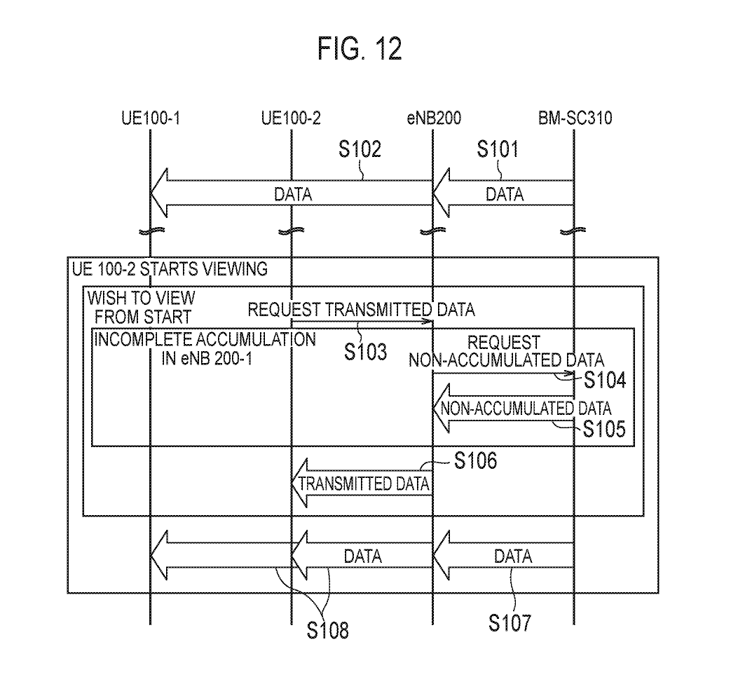

FIG. 12 is a sequence diagram showing the delivery control in the eNB 200.

As shown in FIG. 12, in step S101, the BM-SC 310 transmits the MBMS data to the eNB 200. In step S102, the eNB 200 that has received the MBMS data delivers the MBMS data to the UE 100-1. Thereafter, the UE 100-2 starts the reception and the playback (viewing) of the MBMS data, and wishes the reception and the playback (viewing) from a start of the MBMS data.

In step S103, the UE 100-2 transmits a request of the unicast delivery of a delivered data portion (first MBMS data portion) to the eNB 200. Here, it is assumed that the delivered data portion (first MBMS data portion) is non-accumulated in the eNB 200.

In step S 104, the eNB 200 that has received the unicast delivery request transmits the transmission request of the non-accumulated part of the MBMS data to the BM-SC 310. In step S105, the BM-SC 310 that has received the transmission request transmits the non-accumulated part of the MBMS data to the eNB 200. In step S 106, the eNB 200 that has received the non-accumulated part of the MBMS data transmits (deliveries by unicast) the received MBMS data to the UE 100-2.

In step S107, the BM-SC 310 transmits the MBMS data to the eNB 200. In step S108, the eNB 200 that has received the MBMS data delivers the MBMS data to the UE 100-1 and the UE 100-2.

(4) Unicast Delivery Control

Unicast delivery control of the first MBMS data portion will be described, below.

An operation pattern 1 of the unicast delivery control includes: a step of requesting, by the UE 100-2, to the network, unicast delivery from a start of the MBMS data; and a step of requesting the network to stop the unicast delivery in response to receipt of the MBMS data corresponding to the first MBMS data portion from the network. That is, in the operation pattern 1, the unicast delivery is controlled by the initiative of the UE 100-2.

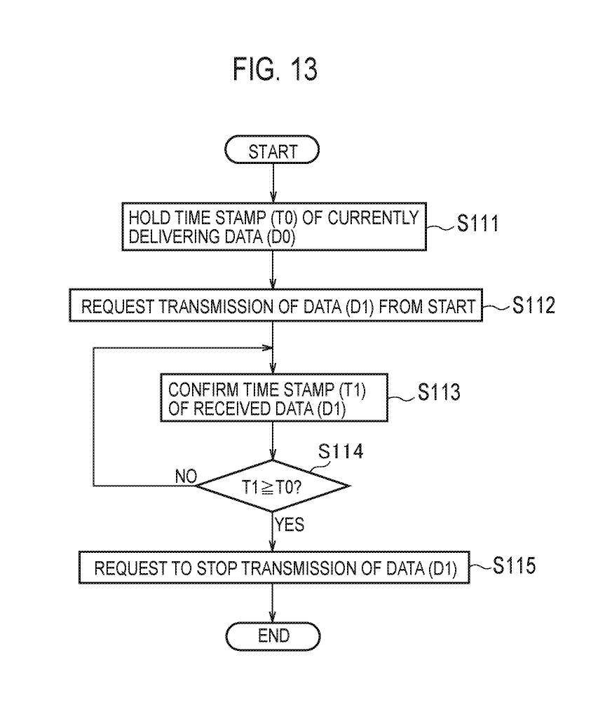

FIG. 13 is a flowchart showing the operation pattern 1 of the unicast delivery control.

As shown in FIG. 13, in step S111, when starting the reception of the MBMS data at the second time, the UE 100-2 holds a time stamp (T0) of currently delivering data (D0). Here, the time stamp is a time stamp of the MBMS data.

In step S112, the UE 100-2 requests the network to transmit (delivery by unicast) unreceived data (D1).

In step S113, the UE 100-2 confirms a time stamp (T1) of the data (D1) while receiving and playing back the data (D1) being delivered by unicast from the network. When the time stamp (T1) is equal to or more than the held time stamp (T0) (step S114; YES), in step S115, the UE 100-2 requests the network to stop the delivery of the data (D1).

An operation pattern 2 of the unicast delivery control includes: a step of delivering by unicast, by the eNB 200, to the UE 100-2, from a start of the MBMS data; and a step of stopping the unicast delivery and notifying the UE 100-2 of the stopping of the unicast delivery, in response to the unicast delivery of the MBMS data corresponding to the first MBMS data portion to the UE 100-2. That is, in the operation pattern 2, the unicast delivery is controlled by the initiative of eNB 200. It is noted that instead of the eNB 200, the BM-SC 310 may perform such control.

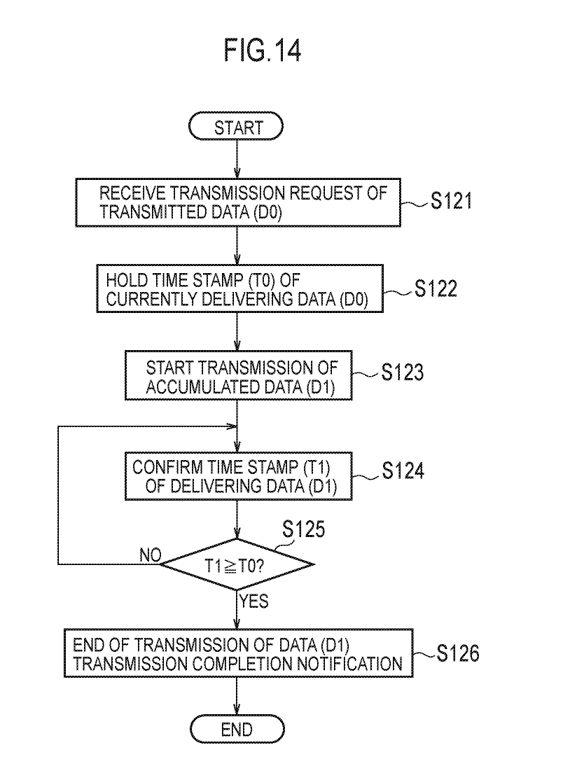

FIG. 14 is a flowchart showing the operation pattern 2 of the unicast delivery control.

As shown in FIG. 14, in step S121, the eNB 200 receives, from UE 100-2, the transmission (unicast delivery) request of transmitted data (D1) of the MBMS data.

In step S122, the eNB 200 holds the time stamp (T0) of the currently delivering data (D0).

In step S123, the eNB 200 starts transmitting (delivering by unicast) the accumulated and transmitted data (D1) to the UE 100-2.

In step S124, the eNB 200 confirms the time stamp (T1) of the data (D11) while delivering the data (D1) by unicast to the UE 100-2. When the time stamp (T1) is equal to or more than the held time stamp (T0) (step S125; YES); in step S126, the eNB 200 ends the unicast delivery of the data (D1) and transmits a transmission completion notification to the UE 100-2. It is noted that when receiving the transmission completion notification, the UE 100-2 switches the data to be played back from the data (D1) to the delivering data (D0) being accumulated in the reception buffer.

It is noted that in FIG. 13 and FIG. 14, instead of the time stamp, a data amount of the MBMS data, a memory address in a storage memory, a synchronization signal (provided by the MBMS GW) of the MBMS data, or the like may be used.

### Second Embodiment

In a second embodiment, a difference from the first embodiment will be mainly described. The second embodiment is similar to the first embodiment in regard to the system configuration.

### MBMS Control Method According to Second Embodiment

An MBMS control method according to the second embodiment will be described, below. The MBMS control method according the second embodiment is a method for appropriately establishing a method of delivering the MBMS data (unicast delivery, broadcast/multicast delivery).

In the second embodiment, when the number of the delivery request UEs of the MBMS data is singular, the network (the eNB 200, the BM-SC 310, or the MCE330) starts the unicast delivery of the MBMS data.

Further, when the number of delivery request UEs increases from singular to plural, the network switches the delivery of the MBMS data from by unicast to by broadcast/multicast. On the other hand, when the number of delivery request UEs decreases from plural to singular, the network has a step of switching the delivery of the MBMS data from by broadcast/multicast to by unicast.

Further, when switching the delivery of the MBMS data from by unicast to by broadcast/multicast or when switching the delivery of the MBMS data from by broadcast/multicast to by unicast, the network transmits a delivery switch notification to the delivery request UE. Specifically, when the delivery is switched from by unicast to by broadcast/multicast, a delivery switch notification indicating a switch to by broadcast/multicast is transmitted. On the other hand, when the delivery is switched from by broadcast/multicast to by unicast, a delivery switch notification indicating a switch to by unicast is transmitted. Thus, a delivery request UE is capable of understanding the method of delivering the MBMS data and continuing to receive the MBMS data.

In the second embodiment, when the MBMS data is not being delivered by broadcast/multicast, the UE 100 in the RRC idle state establishes a connection with the network and then requests the network to deliver the MBMS data.

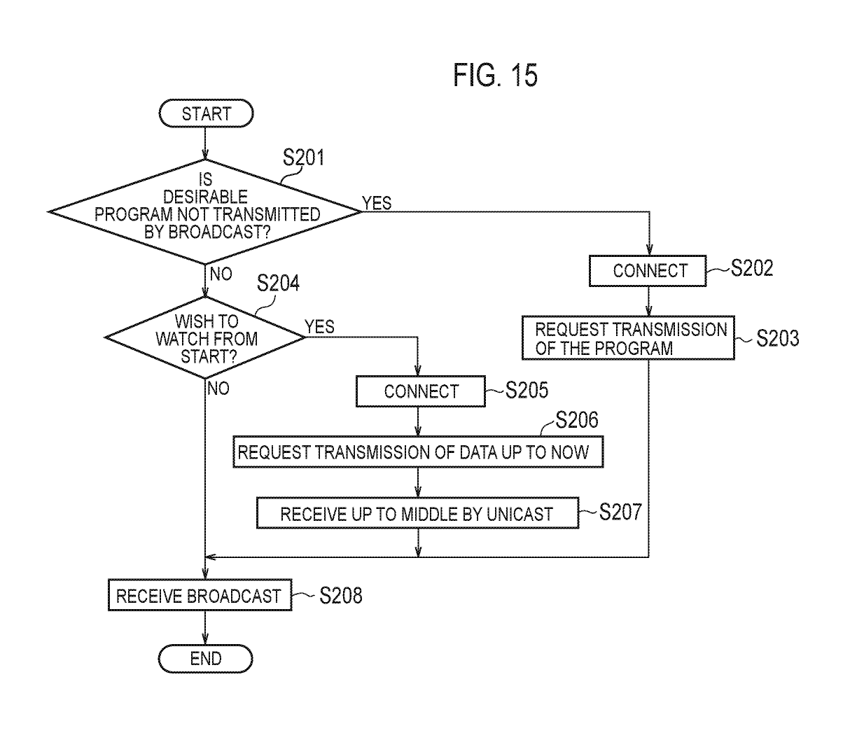

FIG. 15 is a flowchart showing the operation pattern 1 according to the second embodiment. The operation pattern 1 is a pattern in which the broadcast/multicast delivery is started, on the basis of the UE 100 that has requested the delivery of the MBMS data.

As shown in FIG. 15, in step S201, the UE 100 in the RRC idle state determines whether or not the desired MBMS data (for example, a desirable program) is delivered by broadcast/multicast.

When the desired MBMS data is not delivered by broadcast/multicast (step S201; YES), in step S202, the UE 100 in the RRC idle state connects to the network and transitions to an RRC connection state. Then, the UE 100 requests, to the network, the broadcast/multicast delivery of the MBMS data (step S203), and receives the MBMS data delivered by broadcast/multicast (step S208).

On the other hand, when the desired MBMS data is delivered by broadcast/multicast (step S201: NO), in step S204, the UE 100 in the RRC idle state confirms whether or not the playback (viewing) from a start of the MBMS data is wished. When not wished (step S204: NO), the UE 100 receives the MBMS data to be delivered by broadcast/multicast (step S208).

When the playback from a start of the MBMS data is wished (step S204: YES), in step S205, the UE 100 in the RRC idle state connects to the network and transitions to the RRC connection state. Then, according to the method described in the first embodiment, the UE 100 requests, to the network, the unicast delivery of the data up to this point (unreceived data) (step S206), receives the unreceived data delivered by unicast (step S207), and further receives the MBMS data delivered by broadcast/multicast (step S208).

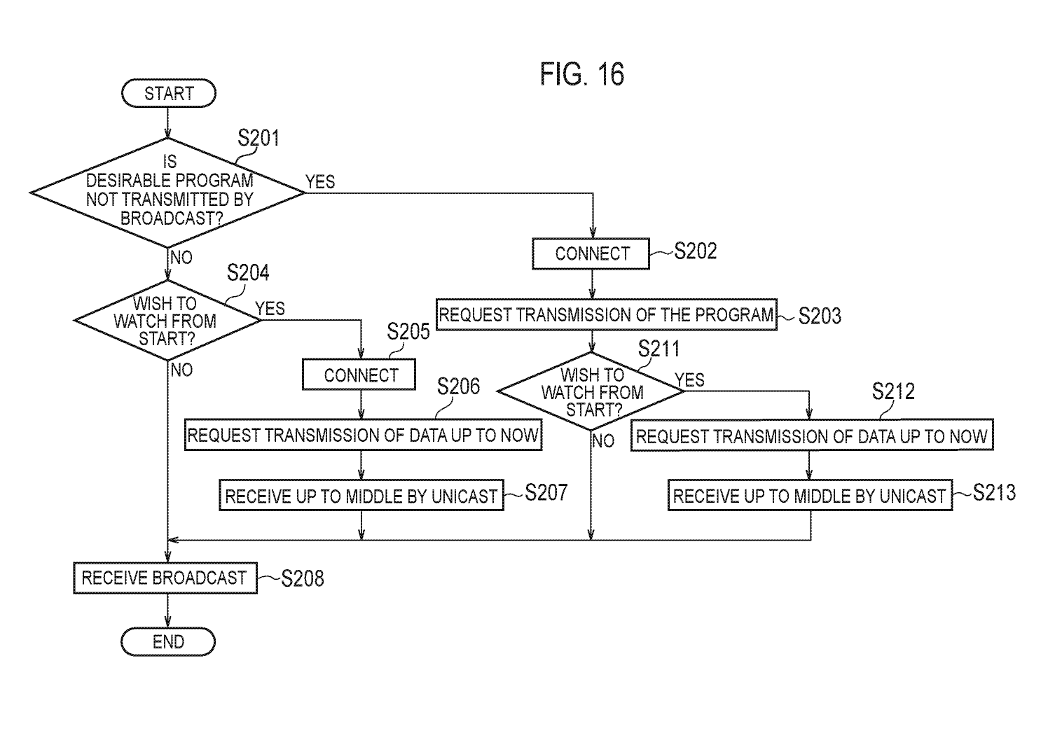

FIG. 16 is a flowchart showing an operation pattern 2 according to the second embodiment. The operation pattern 2 is a pattern in which the delivery start time of the MBMS data is fixed.

As shown in FIG. 16, the operation pattern 2 is a procedure different in steps S211 to S213 from the operation pattern 1.

In step S201, the UE 100 in the RRC idle state determines whether or not the desired MBMS data (for example, a desirable program) is delivered by broadcast/multicast. Then, when the desired MBMS data is not delivered by broadcast/multicast (step S201; YES), the UE 100 connects to the network and transitions to the RRC connection state (step S202), and requests, to the network, the broadcast/multicast delivery of the MBMS data (step S203).

In step S211, the UE 100 confirms whether or not the payback (viewing) from a start of the MBMS data is wished. When it is not wished (step S211: NO), the UE 100 receives the MBMS data delivered by broadcast/multicast (step S208). On the other hand, when the playback from a start of the MBMS data is wished (step S211: YES), in step S212, according to the method described in the first embodiment, the UE 100 requests, to the network, the unicast delivery of the data up to this point (unreceived data) (step S212), receives the unreceived data delivered by unicast (step S213), and further receives the MBMS data delivered by broadcast/multicast (step S208).

It is noted that in FIG. 15 and FIG. 16, when an initial state of the UE 100 is the RRC connection state, it is possible to omit the steps of connecting to the network.

### Other Embodiments

The first embodiment and the second embodiment described above may be individually and independently implemented, and also may be implemented in combination of two or more embodiments.

Further, in each of the above-described embodiments, the LTE system is described as an example of the mobile communication system; however, the present disclosure may be applied not only to the LTE system but also to a system other than the LTE system.

It is noted that the entire content of Japanese Patent Application No. 2014-032299 (filed on Feb. 21, 2014) is incorporated herein by reference.

### INDUSTRIAL APPLICABILITY

Thus, the MBMS control method, the user terminal, and the base station according to the present embodiment is useful in the field of mobile communication because it is possible to play back MBMS data from a start even when the MBMS data is intercepted.

1. An MBMS control method used in a mobile communication system, comprising:
a step of starting, by a network, delivery of MBMS data at a first time;
a step of starting, by a user terminal, reception of the MBMS data at a second time later than the first time; and
a step of requesting, by the user terminal, to the network, unicast delivery of a first MBMS data portion that is the MBMS data delivered between the first time and the second time.

2. The MBMS control method according to claim 1, further comprising:
a step of accumulating, by the user terminal, a second MBMS data portion that is the MBMS data that is started to be received at the second time in a reception buffer; and
a step of playing back, by the user terminal, the MBMS data in the order of the first MBMS data portion to the second MBMS data portion on receiving the first MBMS data portion delivered by unicast from the network.

3. The MBMS control method according to claim 2 wherein, in the step of playing back, the user terminal plays back the MBMS data at a predetermined playback speed faster than a standard playback speed so that the playback of the MBMS data is completed by a third time when the delivery of the MBMS data is ended.

4. The MBMS control method according to claim 3, further comprising: a step of displaying, when the playback of the MBMS data is not completed by the third time, even if the MBMS data is played back at the predetermined playback speed, by the user terminal, an indication to that effect on a user interface.

5. The MBMS control method according to claim 1, further comprising:
a step of accumulating, by a base station comprised to receive the MBMS data from an originating device of the MBMS data in the network, after starting delivering the MBMS data at the first time, the delivered MBMS data; and
a step of delivering by unicast, on the basis of the request for the unicast delivery, by the base station, the accumulated MBMS data as the first MBMS data portion, to the user terminal.

6. The MBMS control method according to claim 5, further comprising:
a step of holding without discarding for a fixed time period, by the base station, the accumulated MBMS data: and
a step of acquiring, when at least a part of the first MBMS data portion of which the unicast delivery is requested is not accumulated, by the base station, the part which is not accumulated, from the originating device.

7. The MBMS control method according to claim 1, wherein the step of requesting includes:
a step of requesting, by the user terminal, to the network, to delivery by unicast from a start of the MBMS data; and
a step of requesting, by the user terminal, the network to stop the unicast delivery in response to receipt, from the network, of the MBMS data corresponding to the first MBMS data portion.

8. The MBMS control method according to claim 5, wherein the step of delivering by unicast includes:
a step of delivering by unicast, by the base station, from a start of the MBMS data, to the user terminal; and
a step of stopping, by the base station, the unicast delivery and notifying the user terminal of the stopping of the unicast delivery, in response to having delivered by unicast the MBMS data corresponding to the first MBMS data portion, to the user terminal.

9. The MBMS control method according to claim 1, wherein in the step of starting delivery of MBMS data, the network starts to deliver by unicast the MBMS data when the number of delivery request terminals of the MBMS data is singular, and
the MBMS control method further comprises:
a step of switching, by the network, the delivery of the MBMS data from by unicast to by broadcast/multicast, when the number of delivery request terminals increases from singular to plural.

10. The MBMS control method according to claim 9, further comprising a step of switching, by the network, the delivery of the MBMS data from by broadcast/multicast to by unicast, when the number of delivery request terminals decreases from plural to singular.

11. The MBMS control method according to claim 9, further comprising: a step of transmitting, by the network, a delivery switch notification to the delivery request terminal, when switching the delivery of the MBMS data from by unicast to by broadcast/multicast or when switching the delivery of the MBMS data from by broadcast/multicast to by unicast.

12. The MBMS control method according to claim 9 further comprising: a step of requesting, by a user terminal in an idle state, the network to deliver the MBMS data after establishing a connection with the network, when the MBMS data is not delivered by broadcast/multicast.

13. A user terminal configured to start receiving MBMS data at a second time, after a network starts delivering the MBMS data at a first time, in a mobile communication system, comprising:
a controller configured to requests, to the network, unicast delivery of a first MBMS data portion that is the MBMS data delivered between the first time and the second time.

14. A base station configured to deliver MBMS data in a mobile communication system, comprising:
a controller configured to accumulate, after starting delivering the MBMS data, the delivered MBMS data, wherein
the controller delivers by unicast the accumulated MBMS data to a user terminal, on a basis of a request for unicast delivery from the user terminal.
